(19) United States
(12) Patent Application Publication
(10) Pub. No.: US 2011/0189900 A1
(43) Pub. Date: Aug. 4, 2011

(54) CABLE ASSEMBLY WITH IMPROVED TERMINATING MEANS AND METHOD OF MAKING THE SAME

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/015,250

(22) Filed: Jan. 27, 2011

(30) Foreign Application Priority Data
Feb. 4, 2010 (CN) 201010301172.4

(51) Int. Cl. H01R 13/415; H01R 43/00

(52) U.S. Cl. 439/741; 29/825

(57) ABSTRACT

A cable assembly (1000) includes an insulative housing (11); a cable (14) having an insulative jacket (143) and a plurality of wires (141) enclosed by the insulative jacket; a plurality of contacts (13) mounted to the insulative housing, and each of the contacts having a retention portion, a mating portion and a tail portion (1313), the tail portion having a taper end inserted into a corresponding wire along an axial direction; and a ferrule (12) crimped to the insulative jacket to retain the wires and the tail portion therein.

### BACKGROUND OF THE INVENTION

1. Field of the Invention

The present invention relates to a cable assembly, especially to a cable assembly with improved terminating means.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a cable having an insulative jacket and a plurality of wires enclosed by the insulative jacket; a plurality of contacts mounted to the insulative housing, and each of the contacts having a retention portion, a mating portion and a tail portion, the tail portion having a taper end inserted into a corresponding wire along an axial direction; and a ferrule crimped to the insulative jacket to retain the wires and the tail portion therein.

Accordingly, to achieve above-mentioned object, a method of making a cable assembly comprises steps of: providing an insulative housing; providing a plurality of contacts and mounting the contacts to the insulative housing, with tail portions of the contacts disposed behind the insulative housing; providing a cable which has a number of wires and an insulative jacket enclosing the wires; adjusting relation between the cable and the contacts to have the wires respectively align with the tail portions of the contacts along an axial direction; moving the cable or the insulative housing to urge the tail portions penetrating into the wires along the axial direction.

The detailed features of the present invention will be apparent in the detailed description with appropriate reference to the accompanying drawings.

### BRIEF DESCRIPTION OF THE DRAWINGS

FIG. 1 is a perspective view of a cable assembly of in accordance with the present invention;

FIG. 2 is an exploded, perspective view of the cable assembly in FIG. 1;

FIG. 3 is similar to FIG. 2, but viewed from other aspect; and

FIG. 4 is a cross-section view of the FIG. 1 taken along a line 4-4.

### DETAILED DESCRIPTION OF THE INVENTION

Reference will now be made in detail to the preferred embodiment of the present invention.

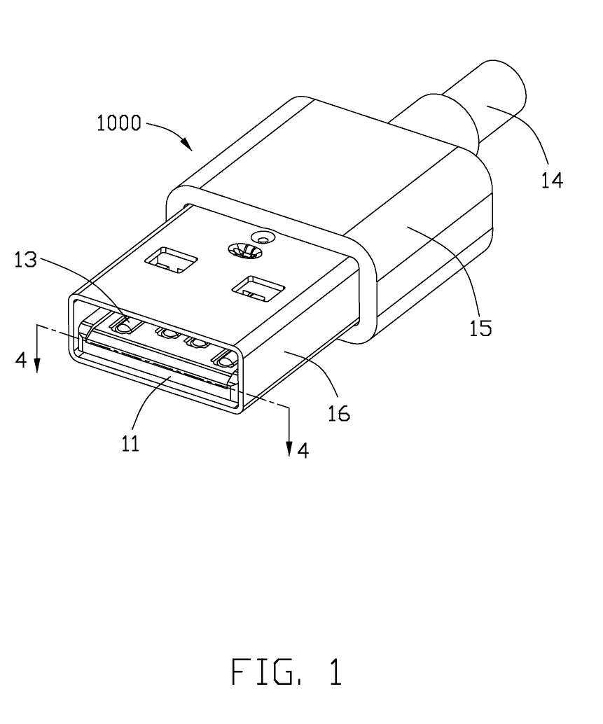

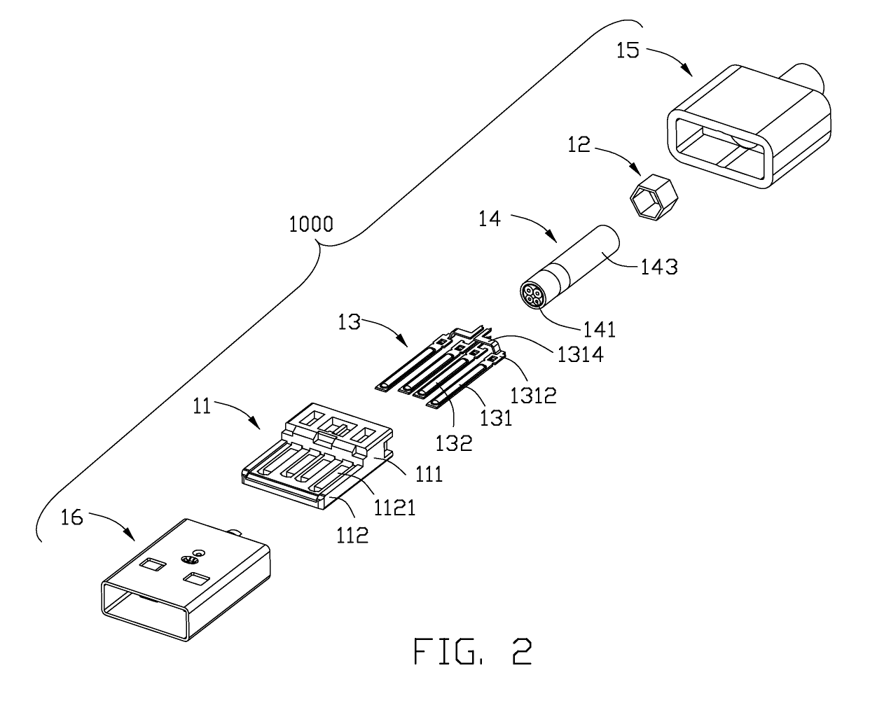

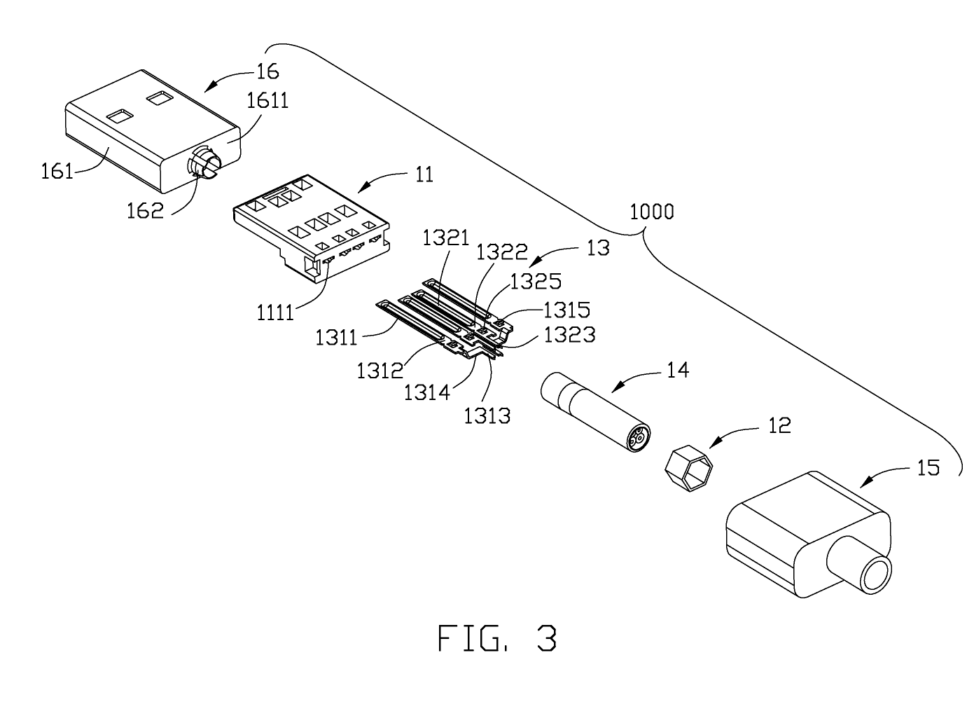

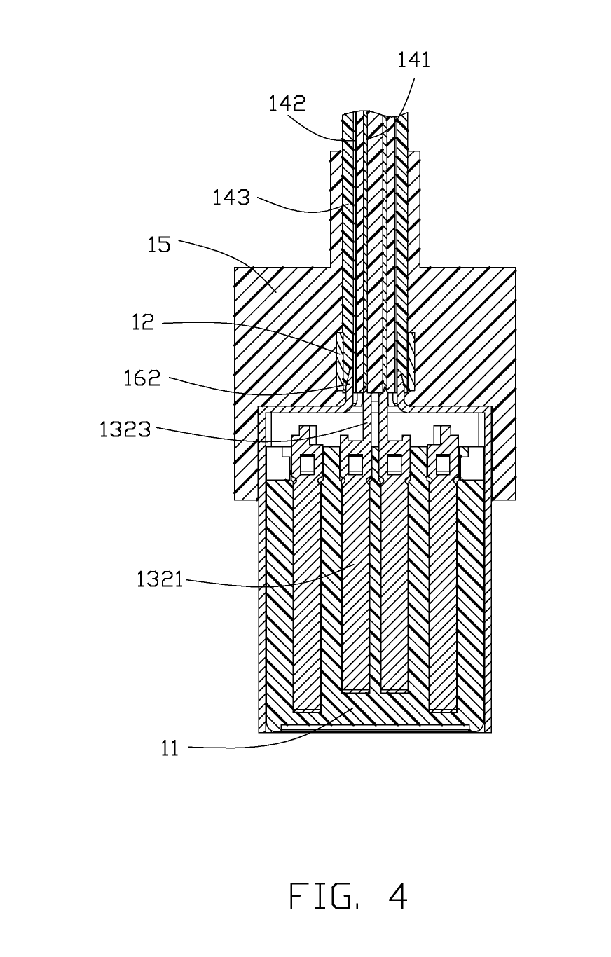

Referring to FIGS. 1-4, a cable assembly 1000 in accordance with the present invention is compatible with Universal Serial Bus (USB). The cable assembly 1000 includes an insulative housing 11, a ferrule 12, a plurality of contacts 13, a cable 14, an insulative cover 15 and a metallic shell 16.

The insulative housing 11 has a base portion 111 and a tongue portion 112 extending forwardly from the base portion 111. The base portion 11 is thicker than the tongue portion 112. There are a number of slots 1111 defined in the base portion and extending along a front-back-direction. Also, a number of grooves 1121 are located in a top side of the tongue portion 112 and align with the slots 1111, respectively. Both the slots 1111 and the grooves 1121 are arranged in a row along a transversal direction.

There are four contacts 13 in the embodiment. Two first contacts 131 are disposed at opposite sides and two second contacts 132 located between the two first contacts 131. Each first contact 131 has a retention portion 1312, a mating portion 1311 extending forwardly from the retention portion 1312, a L-shaped mediate portion 1314 raised from a back portion of the retention portion 1312 and extending inwardly therefrom, and a tail portion 1313 extending backwardly from an end of the mediate portion 1314. The tail portion 1313 has a taper/sharp free end. Each second contact 132 has a retention portion 1322, a mating portion 1321 extending forwardly from the retention portion 1322, and a tail portion 1323 extending backwardly from an end of the retention portion 1322. The tail portion 1323 has a taper/sharp free end. In addition, there is a barb 1315/1325 upwardly projects from the retention portion 1312/1322. Two tail portions 1313 of the two first contacts 131 are disposed adjacent to each other and arranged at a first level. Two tail portions 1323 of the two second contacts 132 are disposed adjacent to each other and arranged at a second level which is under the first level. A distance between the tail portions 1313 of the first contacts 131 is equal to a distance between the tail portions 1323 of the second contacts 132. Of course, the number of the first contacts 131 and the second contacts 132 may be more than two. By such arrangement, tail portions 1313/1323 are compact. The contacts 13 are assembled to the insulative housing 11 along a front-to-back direction, with the mating portion 1311/1321 accommodated in the corresponding groove 1121, the retention portion 1312/1322 inferentially received in the corresponding slot 1111, and the tail portion 1313/1323 disposed behind the base portion 111 of the insulative housing 11.

The cable 14 is a round type cable, which includes four wires 141, a metallic braiding 142 enclosing the wires 141 and an insulative jacket 143 enclosing the metallic braiding 142. Each wire 141 has an inner conductor with a layer of outer insulator.

The metallic shell 16 has a rectangular shaped frame portion 161 and a cylindrical shaped extension portion 162 projecting backwardly from the frame portion 161.

When assembly, the insulative housing 11 is mounted into the frame portion 161 and the tail portions 1313, 1323 are disposed in the extension portion 162, then by adjusting the cable 16 and having the wires 141 aligning with the tail portions 1313/1323 along an axial direction, pushing the insulative housing 11 backwardly movement to let the tail portions 1313, 1323 inserting/penetrating into the wires 141 along the axial direction of the cable 14, thus the tail portions 1313, 1323 respectively contacting with the inner conductors of the wires 141 to form electrical connection therebetween. The extension portion 162 is inserted between the metallic braiding 142 and the insulative jacket 143. The ferrule 12 is mounted/crimped to an outside of the insulative jacket 143 to squeeze the extension portion 162 and the metallic braiding 142 so as to retain the tail portions 1313, 1323 and the wires 141. Finally, the insulative cover 15 is molded over a back segment of the metallic shell 16, a front segment of the cable 14 and the ferrule 12.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a cable having an insulative jacket and a plurality of wires enclosed by the insulative jacket;
a plurality of contacts mounted to the insulative housing, and each of the contacts having a retention portion, a mating portion and a tail portion, the tail portion having a taper end inserted into a corresponding wire along an axial direction; and
a ferrule crimped to the insulative jacket to retain the wires and the tail portions therein.

2. The cable assembly as claimed in claim 1, wherein the contacts includes first contacts and second contacts, and the mating portions of the first contacts and second contacts are arranged in a row, and the tail portions of the first contacts and the second contacts are spaced from each other along a vertical direction.

3. The cable assembly as claimed in claim 2, wherein there are two first contacts and two second contacts disposed between the two first contacts.

4. The cable assembly as claimed in claim 3, wherein the first contact further has a mediate portion connecting the retention portion and the tail portion.

5. The cable assembly as claimed in claim 4, wherein the mediate portion extends upwardly and inwardly from the retention portion.

6. The cable assembly as claimed in claim 5, wherein the mediate portion is L-shaped.

7. The cable assembly as claimed in claim 1, wherein the cable further includes a metallic braiding enclosing the wires and within the insulative jacket.

8. The cable assembly as claimed in claim 7, further comprising a metallic shell.

9. The cable assembly as claimed in claim 8, wherein the metallic shell includes a rectangular shaped frame portion enclosing the insulative housing and a cylindrical shaped extension portion projecting backwardly from the frame portion inserted between the insulative jacket and the metallic braiding.

10. The cable assembly as claimed in claim 1, wherein the cable is a round type cable.

11. A method of making a cable assembly comprising steps of:
providing an insulative housing;
providing a plurality of contacts and mounting the contacts to the insulative housing, with tail portions of the contacts disposed behind the insulative housing;
providing a cable which has a number of wires and an insulative jacket enclosing the wires;
adjusting relation between the cable and the contacts to have the wires respectively align with the tail portions of the contacts along an axial direction;
moving the cable or the insulative housing to urge the tail portions penetrating into the wires along the axial direction.

12. The method of making the cable assembly as claimed in claim 11, wherein each of the tail portions has a sharp end.

13. The method of making the cable assembly as claimed in claim 11, further comprising a step of providing a ferrule and crimping the ferrule to the insulative jacket to retain the wires and the tail portions therein.

14. The method of making the cable assembly as claimed in claim 11, wherein the cable is a round type cable.

15. The method of making the assembly as claimed in claim 14, further comprising a step of providing a metallic shell and assembled the metallic shell to the insulative housing.

16. The method of making the cable assembly as claimed in claim 15, wherein the metallic shell has a cylindrical shaped extension portion inserted into the cable along the axially direction.

17. An electrical connector comprising:
an insulative housing defining a mating face thereon;
a plurality of contacts disposed in the housing, each of said contacts including a contacting section exposed upon the mating face and a tail section extending rearwardly;
a metallic shell having a frame portion enclosing said housing and an extension portion extending rearwardly from the frame portion; and
a cable including a plurality of inner conductive wires an outer braiding layer surrounding said inner conductive wires; wherein
the tail sections are aligned with and inserted into the corresponding inner conductive wires in an axial direction for electrical signal transmission, and the extension portion radially overlapped with the outer braiding layer for grounding.

18. The electrical connector as claimed in claim 17, further including a ferrule surrounding the cable to crimp the cable, the extension portion and the tail sections together.

19. The electrical connector as claimed in claim 17, wherein the tail sections are arranged in a square manner while the contacting sections are arranged in a spanned manner.

20. The electrical connector as claimed in claim 17, wherein said extension portion defines a cylindrical configuration.
